(19) United States
(12) Patent Application Publication
(10) Pub. No.: US 2025/0053438 A1
(43) Pub. Date: Feb. 13, 2025

(54) MAP/REDUCE CONTROLLER SCHEDULER

(71) Applicant: LiveIntent, Inc., New York, NY (US)

(72) Inventors: Emil Ejbyfeldt, Malmo (SE); Søren Holbech, Vejle (DK); Niels Boldt, Bronshoj (DK)

(21) Appl. No.: 18/766,563

(22) Filed: Jul. 8, 2024

Related U.S. Application Data
(60) Provisional application No. 63/525,710, filed on Jul. 9, 2023.

(51) Int. Cl. G06F 9/46

(52) U.S. Cl. CPC G06F 9/466

(57) ABSTRACT

The inventions related to Map/Reduce, a big data platform that helps in running large scale data processing jobs, e.g. spark jobs, in a batch pipeline used for building an Identity Graph and other data products.

### BACKGROUND OF THE INVENTION

### Field of Invention

The inventions disclosed herein generally relate to Map/Reduce, a big data platform that helps in running large scale data processing jobs. Jobs may include spark jobs, potentially in a batch pipeline, and may be used for building Identity Graphs and other data products.

### BRIEF DESCRIPTION OF THE DRAWINGS

FIG. 1 illustrates a Map/Reduce architecture diagram.

FIG. 2 illustrates exemplary potential system elements.

### DETAILED DESCRIPTION OF EMBODIMENTS OF THE INVENTION

Map/Reduce [MR] is a platform for executing jobs, e.g. spark jobs, in a batch pipeline, used for building an Identity Graph and other data products. MR optimizes monetary costs and ease for developers around batch processing, enabling an engineer/user to focus on business logic, and not an underlying execution engine. MR preferably saves substantial costs by running workloads on spot instances and avoiding EMR license fees.

MR preferably consist of two main components MRSS (MR Scheduler Service) and MR controller.

MRSS may be, e.g., a Play App, or other app, e.g. written in Scala that is used to start/stop jobs and it communicates with MR controller. So the primary responsibility of MRSS is preferably to schedule a batch job to a cluster and when the job can be started. The interface to MRSS may be a http api. MRSS abstracts the complexity of running a Spark job away for the developer, because MRSS provides a centralized http api where all relevant information about a job can be extracted including error messages that are often hard to get hold of in distributed systems.

MRSS can take as input a job request which may a json object, for example potentially looking like:

{
“jarUri”: “s3://releases.private.mojn.com/snapshots/
spark-dwh/spark-dwh_2.12/2.2148.0-GA-95-
add-scoring-comparison-SNAPSHOT/
spark-dwh_2.12-2.2148.0-GA-95-add-scoring-
comparison-SNAPSHOT-assembly.jar”,
“jobType”: “Spark”,
“jobArgs”: {“ -- system”: “s3”, “ -- date”: “2022-09-18”},
“jobName”: “com.liveintent.dwh.reports.
DormantEmailScoringReportJob” ,
“jobLabel”: “ReactivationCountsSparkJob-2022-02-24-1”,
“jobCostCenter”: “internal_aggregates”,
“jobRuntime”: {“backendType”: “MR”}
}

So the input above points to a jar file, contains which class that should be executed and eventual parameters and job configuration like cluster type, size and other custom configurations. MRSS then maintains a queue of active jobs and if it can find an active cluster that matches the configuration with capacity the job is preferably scheduled to run on that cluster. The user can then query MRSS for information about the actual job.

There has also been focus on increasing developer productivity such as automatic extraction of error messages and diagnostics for failed Spark Jobs. With MR, an engineer should only worry about the business logic when writing a job and the rest is taken care of by an underlying system.

So now we are at a stage where we can preferably submit jobs through a http api taking a json file as input and through the same api we can extract error messages, job status and job diagnostics.

MR controller preferably orchestrates and manages running clusters, e.g. Spark clusters such as controller, idle-termination and manager for commissioning new nodes to the cluster. A cluster of ec2 instances may be provisioned using a CloudFormation stack and instance types in the cluster is selected based on some criteria like for example: Size of the nodes (e.g. chosen by the user); Type of node (e.g. memory, general, storage, preferably chosen by the user); Decommission rates in AWS or similar services; and Spot price.

So for each combination of (size, type) there preferably exists a list of instance types that can be used and those instance types are mixed into a cluster which allows us to use e.g ec2 instances that we cannot use on EMR as EMR doesn't support all ec2 instance types that you can utilize through the AWS or similar cloud which reduces competition on the instance types used by MR.

In summary, MR controller is preferably responsible for provisioning clusters and managing cluster scaling that was built to optimize costs and robustness of processing. To optimize costs MR controller preferably utilizes spot instances and supports adding additional storage into a cluster when needed. To optimize for robustness MR controller prefers many but small clusters instead of few but large clusters. So processing capacity scaling is preferably mainly controlled by the number of clusters running instead of resizing an individual cluster. For robustness of processing we preferably define our own storage layer of EBS drives, e.g. using BTRFS, which enables us to attach more and more disks and grow with the load outside of the mandated EBS mandatory waiting time of, e.g., ˜6 hours before resizing again. The reason for this choice is that as long as a Spark job has sufficient storage capacity it is theoretically possible to complete.

In addition we preferably have detailed standard incident analysis logs that include cluster level node level and job level event information. These logs are preferably pushed to AWS S3 or similar for persistence so we allow analysis after a cluster has been terminated. On top of those logs, a metric and event monitoring layer is preferably situated. The layer helps increase operational efficiency (e.g. by automatically detecting that a job failed due to an unstable cluster and can be restarted; and by presenting meaningful standard stack traces in the scheduler logs). The layer is preferably implemented as a separate process the processes all logs collected and aggregates meaningful information.

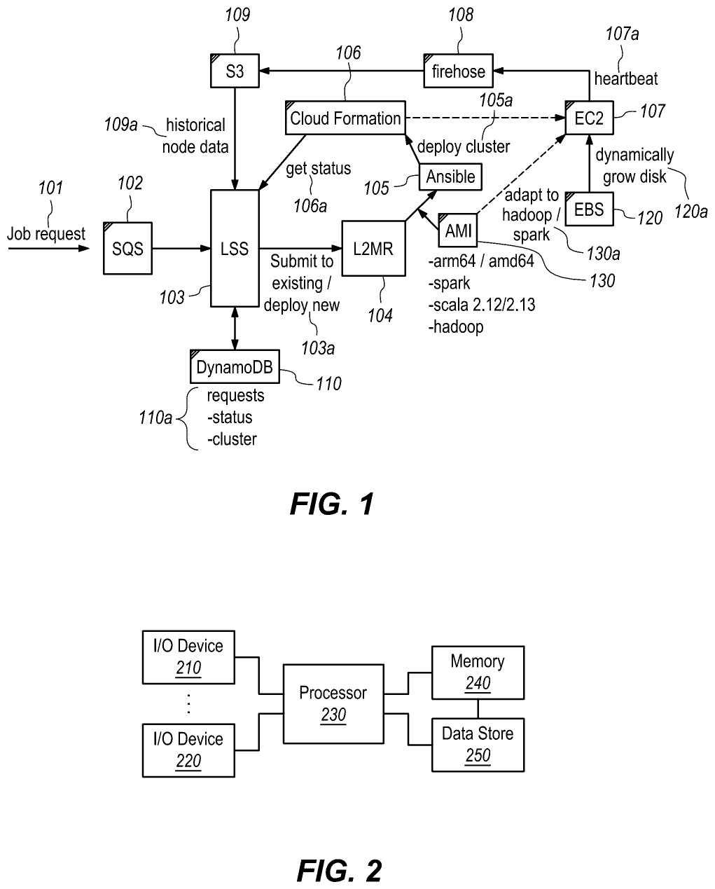

See MR architecture diagram, FIG. 1.

Embodiments of the invention may include: big data platform for executing spark jobs in a batch pipeline used for building data products, comprising: a scheduler service, comprising an app written in Scala, capable of starting and/or stopping jobs, where the scheduler service abstracts the complexity of running a Spark job away from a developer; a controller, capable of communication with the scheduler service, the controller orchestrating and managing running Spark clusters, provisioning clusters, and managing cluster scaling; where the scheduler service can take as input a job request including a json object; where the schedule service can maintain a queue of active jobs, and can match job configuration with capacity for the job to run on a cluster.

Embodiments of the invention may include where jobs can be submitted through an http api, taking a json file as input, where the api response can be used to extract error messages, job status, and job diagnostics; where the controller utilizes spot instances, and supports adding additional storage into a cluster when needed; including incident analysis logs including cluster level information, node level information, and job level information; or including a metric and event monitoring layer.

For a more complete understanding of various embodiments of the present invention, reference is now made to the following descriptions taken in connection with the accompanying drawings.

FIG. 1 illustrates an MR architecture diagram, starting with job request 101, fed into LSS 103, which can extract from DynamoDB 110, including requests, status, and cluster 110a. At 103a, LSS 103 submits to existing or deploys new, to L2MR 104, via AMI 130, which may include arm64/amd64; spark; scala 2.12/2.13; Hadoop. L2MR 104 sends to Ansible 105, deploy cluster 105a to Cloud Formation 106, via get status 106a to LSS 103. Cloud Formation 106 can also point to EC2 107. EBS 120, via dynamically grow disc 120a, into EC2 107, or AMI 130 via adapt to Hadoop/spark 130a into EC2 107, then via heartbeat 107a into firehose 108, into S3 109, sending historical node data 109a to LSS 103.

FIG. 2 illustrates exemplary potential system elements. As illustrated in FIG. 2, the system may include components including input/output device 210, input/output device 220, processor 230, memory 240, and data store 250.

As will be realized, the systems and methods disclosed herein are capable of other and different embodiments and its several details may be capable of modifications in various respects, all without departing from the invention. For example, specific implementation technology used may be different than those exemplified herein, but would function in a similar manor as described. Accordingly, the drawings and description are to be regarded as illustrative in nature and not in a restrictive or limiting sense.

Figures will be taken as nonlimiting.

1. A big data platform for executing spark jobs in a batch pipeline used for building data products, comprising:
a scheduler service, comprising an app written in Scala, capable of starting and/or stopping jobs, where the scheduler service abstracts away the complexity of running a Spark job;
a controller, capable of communication with the scheduler service, the controller orchestrating and managing running Spark clusters, provisioning clusters, and managing cluster scaling;
where the scheduler service takes as input a job request including a json object;
where the schedule service maintains a queue of active jobs, and matches job configuration with capacity for the job to run on a cluster.

2. The big data platform of claim 1, where jobs are submitted through an http api, taking a json file as input, where the api response is used to extract error messages, job status, and job diagnostics.

3. The big data platform of claim 1, where the controller utilizes spot instances, and supports adding additional storage into a cluster when needed.

4. The big data platform of claim 1, including incident analysis logs including cluster level information, node level information, and job level information.

5. The big data platform of claim 1, including a metric and event monitoring layer.
